(19) United States
(12) Patent Application Publication
(10) Pub. No.: US 2006/0129455 A1
(43) Pub. Date: Jun. 15, 2006

(54) Method of advertising to users of text messaging

(76) Inventor: Kashan Shah, Edmonton (CA)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/304,443

(22) Filed: Dec. 15, 2005

Related U.S. Application Data
(60) Provisional application No. 60/636,193, filed on Dec. 15, 2004.

(51) Int. Cl. G06Q 30/00

(52) U.S. Cl. 705/14

(57) ABSTRACT

A method of advertising to users of text messaging involves serving into an exchange of text messages advertisements, which are linked to selected keywords used in the exchange of text messages.

This application claims priority from U.S. Provisional Patent Application Ser. No. 60/636,193 filed Dec. 15, 2004.

### FIELD OF THE INVENTION

The present invention relates to a method of advertising to users of text messaging.

### BACKGROUND OF THE INVENTION

Internet search engines serve advertisements based upon search terms used. For example, if a user goes to a search engine like GOOGLE (Trade Mark) and types in a phrase: “Movie tickets”; these search terms are searched for in existing web pages and matched against all advertisers paying for ads based on these search terms. The resulting advertisements are sorted based on how much the advertiser is paying for each search term. The highest paying advertiser gets the top spot. The search engine returns with the results of the query and also sends along a set of ads which are then displayed somewhere else on the web page and are usually highlighted as “Sponsored Links.” The resulting ads are always placed somewhere else on the web page, usually along the side of the results returned.

### SUMMARY OF THE INVENTION

According to the present invention there is provided a method of advertising to users of text messaging which involves serving into an exchange of text messages advertisements which are linked to selected keywords used in the exchange of text messages.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a first screen shot of a text messaging screen;

FIG. 2 is a second screen shot of a text messaging screen;

FIG. 3 is a third screen shot of a text messaging screen;

FIG. 4 is a fourth screen shot of a text messaging screen;

FIG. 5 is a fifth screen shot of a text messaging screen;

FIG. 6 is a sixth screen shot of a text messaging screen; and

FIG. 7 is a seventh screen shot of a text messaging screen.

### DETAILED DESCRIPTION OF THE PREFERRED EMBODIMENT

The preferred method of advertising to users of text messaging, as will hereinafter be further described, involves a first step of creating a database of keywords. A second step involves linking at least one advertisement to each keyword in the database of keywords. A third step involves analysing contents of an exchange of text messages sent between users of text messaging for the use of one keyword from the database of keywords. A fourth step involves serving into the exchange of text messages the at least one advertisement which is linked to the one keyword from the database of keywords.

The present invention deals with analyzing a stream of text based messaging taking place between peers and delivering relevant advertisements based on those messages. The text based messaging may take place in any product that allows one or more users to communicate or interact with each other via textual input: a software application running on a computer, a network based messaging program, a web based chat program, or a physical device like a cell phone. In a typical scenario a user's text message is sent to the advertisement system which then delivers the message to all other peers; the original message may be modified to include a single or multiple advertisements.

A list of keywords is generated after analyzing the content of the text messages. The text messages may be analyzed in whole (the entire log of messages during a communication from a particular user or all users combined) or in part (the last message sent by a particular user). There are numerous methods that may be employed in generated a list of keywords: one method could involve keeping only noun words from the messages while another could determine a single keyword for the messages based on word frequency. The list of keywords is then compared against keywords associated with advertisements to determine which advertisement is relevant to the messages. A single or multiple advertisements are then associated with the messages and delivered to the product so that they may be displayed to the user(s). The advertisements can be displayed to an individual user or may be displayed to the entire group of participants.

System Design Figure

This is an overview of the components in which the system may be implemented:

Advertiser

A party wanting to advertise goods or services to users (e.g., Microsoft) or agencies authorized to advertise on behalf of the advertiser. This component includes all data related to advertisers such as billing information, active campaigns, etc.

Advertisement Management

This component includes the advertisements to be displayed for a particular Advertiser, it may be in a variety of forms: textual, audio/visual, or any form capable of being displayed on the consumer device; these may provide embedded tags that allow users to consume the advertisement: for example a link to the advertisers web site or a phone number offering a one time deal if called within a certain time period. Also included are tools to manage ad campaigns by advertisers.

Advertising System

Interfaces the Advertisements to a product; responsible for analyzing text messages and deliver advertisements to the product. Performs a variety of other functions.

Product

The device or program responsible for requesting and displaying advertisements to consumers.

Consumer

The person(s) that receive the advertisement.

System Design Components

Advertiser

Advertiser Management: a system that hosts a list of all advertisers and allows management of their accounts. An advertiser logs onto this system and after being authenticated as the rightful owner they can facilitate all aspects of their advertisement campaign, this includes access to the Advertisement Management system and Advertiser system.

The Advertiser system allows advertisers to manage their contact and billing information along with managing any other data that may be required by the system for advertisers (this includes things like passwords, account information, etc.) Billing information includes data that allows the system to charge advertisers for the services of the system.

This component includes a billing tool that generates invoices for advertisers (either per advertising campaign or as a whole) and may be used by advertisers to monitor expenses over its campaigns. This information is housed in one or more databases.

Advertisement Management

This is a set of components used by advertisers to manage their advertisement campaigns. This system includes the following components: Campaign management and Ad management. These components are software programs that can be used on a computer device or tools that can be used through the internet.

Campaign management: Allows advertisers to create, manage, and monitor ad campaigns. A campaign is a set of advertisements, usually related in some manner, along with a set of data tied to that campaign. For example, PEPSI (Trade Mark) could have a campaign that targets the keyword “thirst” and feature an assortment of advertisements for each of their beverages. A campaign has a set of ads associated with it and each ad may be managed by using the ad management component.

This component includes a statistics tool that allow advertisers to monitor the progress of their campaign (this would include information that would aid the advertiser in judging the effectiveness of each ad and the entire campaign: for example, number of advertisements delivered under the campaign and for each specific ad; number of users that responded to a particular advertisement, list and types of products requesting this ad, demographic information about users requesting the ad, any other information supplied by the product, potential rank of the campaign/likelihood of users messages triggering this ad to be displayed, competing advertisements).

Ad management: Allows advertisers to create, manage, and monitor each advertisement. An advertisement has a set of one or more keywords associated with it and each keyword has a weight, the creative component of the advertisement (the advertisement to be delivered to the consumer), product targeting information (for example, advertisements meant for a specific device or software program), geographic targeting information, a unit value for the advertisement (this may represent a dollar figure to be paid by the advertiser for each advertisement served), a billing method for the advertisement (this may represent the type of cost associated with each advertisement delivered: a one time fixed fee for delivery of a number of ads over a certain period, a fee for each ad served, or a fee for each ad consumed/responded to by the consumer), running periods (start and end dates), statistics (current information about the number of ads served or any other statistics on the advertisement provided back to the advertiser—this would be a subset of statistics provided in the campaign management system), and any other data required by the advertisement.

This component includes tools that aid advertisers in gauging the effectiveness of a set of keywords (for example, “hello” is too common of a keyword and might yield non effective ad placement, a frequency that tells advertisers the chances of this particular ad being displayed and consumed, types of products that generate such keywords, historical statistics for a keyword, current competition for keywords, pricing being used by other advertisers of the same keyword, ranking of the current ad in respect to all other advertisers, unavailable keywords that have been outright purchased by other advertisers), tools to generate a set of stronger keywords and weights based on a list supplied by the advertiser (for example, “pop” may generate “thirsty, drink, soda, beverage”). This data is stored in one or more servers.

Keyword weight entry allows advertisers to apply weights to a set of keywords associated with a certain ad. For example, a Thirst Campaign for Pepsi could include an ad with the following keywords and weights: Thirsty (10%), Drink (10%), Soda (50%), COCA-COLA (Trade Mark) (30%). These keywords and weights are used by the Advertising system in determining the relevancy of an ad to a message. A keyword weight tool allows advertisers to gauge the effectiveness of weights for each keyword and may suggest better weighting schemes or provide an option for automating the weighting process.

The ranking is the percentage of times this advertisement will be delivered when keywords are matched against it. This rank can be computed based on weights of the current advertisement against all other advertisements containing the same keywords.

### EXAMPLE

Advertiser: COCA-COLA (Trade Mark)

Budget per ad served: $1

Keywords: Drink (20%), Pop (30%), Soda (5%), Thirsty (10%), Drinking (15%), Pepsi (20%)

Advertiser: PEPSI (Trade Mark)

Budget per ad served: $5

Keywords: Drink (10%), Pop (20%), Soda (5%), Thirsty (40%), Drinking (15%), Coke (10%)

Total weight for keyword Drink=$1*0.2+$5*0.1=0.7

Rank for Coca-Cola=($1*0.2) 0.7*100%=28.5%

Rank for Pepsi=($5*0.1)/0.7*100%=71.4%

In the preceding example an input of the keyword Drink would result in 3 ads being displayed for Coca-Cola and 7 for Pepsi for every 10 ads served.

A different system may be employed to determine the rank for each advertiser based on their preferred method of payment. Advertisers may also be offered outright purchases of keywords for a particular period, for example an advertiser may elect to purchase the keyword “Car” for a specified term.

Advertising System

This component interfaces the Advertisements to a Product. This system is comprised of the following components: Message processing, Ad matching, Ad delivery, and Ad statistics. This system can be deployed on a computer system and access may be accomplished through a variety of methods: wireless, network, or internet.

On start up the product registers itself with the Advertising system; the product can also deliver other relevant information at this stage such as user demographics and product id (software program or a particular cell phone company) that would aid in selecting an advertisement. The product may request for an advertisement at a particular time or wait for the Advertising system to generate one automatically. Automatic generation can be performed through a variety of means, for example an advertisement might be generated automatically for every 10 messages sent through the system.

Message processing: The product transmits text messages by a user to the Advertising system. The Advertising system could be setup in a way where it is responsible for only delivering an advertisement back to the user or it could modify the current user's message and transmit it to all other users. In the second scenario a particular user's text message is first transmitted to the advertising system which then delivers it to all other users; the original text message can be altered to include advertisements. For example in a software program that allows chatting with other users through the internet: When a user enters a particular chat room the program registers itself with the Advertising system. Whenever a user types a message it is sent to the Advertising system which then delivers it to all other users in the room. All messages are stored in a log; the log may contain all messages sent since the start of a messaging session or only the last few messages.

Ad matching: This process first creates a list of keywords from the log of messages delivered by the product. These keywords are then matched against existing keywords in the ad management database. The matching system may be determined simply by looking for existing keywords in the database or it may apply a more complex algorithm in determining the ad to be served, this could be based on the set of extra information supplied and statistical information stored in the ad database.

For example, if the keyword list from the messages includes “date, movie, club” and an advertisers ad contains “club, the club, car security” then an algorithm may be applied to determine the effectiveness of all keywords in the message against those stored in the ad. In this case “club, the club, car security” may be determined to be an inappropriate advertisement based on the keywords generated. Further elements may be applied in this algorithm that pertain to the product, demographic of user, advertisement value (higher valued ads—those that generate more revenue for the system—are given preference), total number of ads served (averaging system that allows advertisements to be displayed from all sizes of ad budgets), statistical chance of ad being consumed by consumer, etc.

Ad delivery: an advertisement is sent to a product when a product requests for one or at a particular interval as determined by the Advertising system. The advertisements could be displayed in a variety of forms, they may be part of the message stream (such as directly altering a user's message) or could be displayed at an alternate location.

In one implementation for an internet based chat program the last message from a user is altered directly before being sent to other users; the altered message contains the advertisement from the advertiser and features a link to the advertiser:

A user types: “I'm pretty hungry.”

All other users receive:

“I'm pretty hungry.”

“Hungry? Click here to find restaurants near you.”

In another scenario a keyword is highlighted and transformed into a link in the message, all other users receive:

“I'm pretty hungry.”

A user can then select this keyword for further information. In a computer program if the user moves their mouse over the keyword Hungry a text tip may appear that shows more details about this advertisement: “Click to find a restaurant near you!”

In another implementation a combination of altering the user's messages along with delivering visual advertisements may be employed. In the preceding example a visual advertisement from a restaurant may be popped up during the chat.

In another implementation for text based messaging on a cell phone:

A user sends the following message to a friend: “I'm at the supermarket.”

The friend receives:

“I'm at the supermarket.”

“Get low mortgage rates from the Bank of Montreal. Call 1-800-555-4444 to schedule a meeting!”

The number could be dialled instantly by using the cell phone navigation system or it could be a link to a wireless web site for the Bank of Montreal.

Ad statistics: This is a database attached to each advertisement that stores information about the number of times the ad was served, requested, demographics on the requests, devices requesting the ads, the number of times the ad was consumed (acted upon) by the user, and any other information that can be gathered through the advertising system.

Product

This is a physical device or program that interacts with the advertisement system and displays advertisements to consumers. How the ad is displayed to the consumer is dependent on the requirements of the product and the type of ads available in the advertising system.

Consumer

The person(s) that receive the advertisement. Again in the case of MSN Messenger this would be all the users chatting in a particular room.

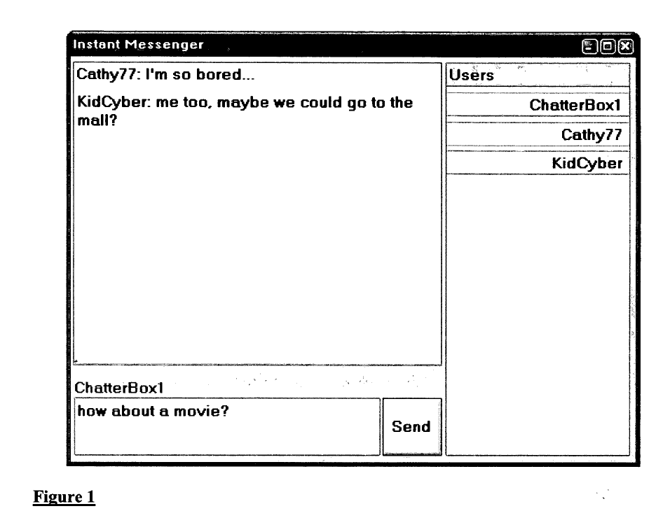

Referring to FIG. 1 through 7, the following series of screen shots illustrate a possible implementation of the system inside an internet instant messaging and chatting program. Referring to FIG. 1, there is illustrated an interface of a typical instant messaging & chatting program.

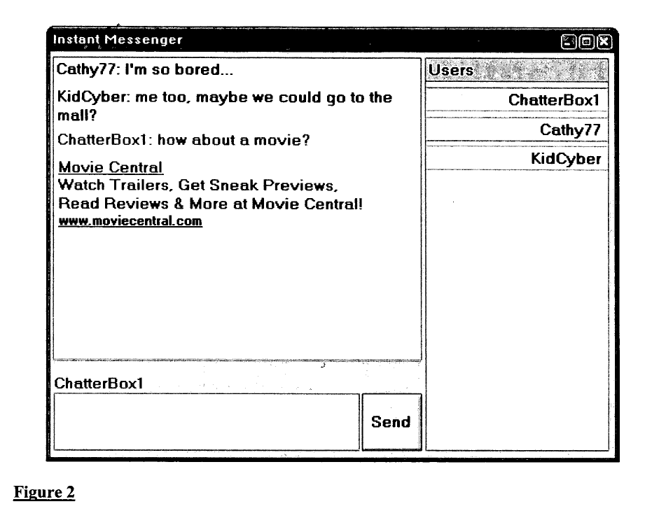

The sidebar panel on the right lists the current clients talking in a particular room. The panel on the left side displays the currently taking place conversation. The panel at the bottom is the chat entry field for the client. The clients name is shown above this field. All text typed by a client is sent to the server for processing and then distributed back to all clients in the current room. The text is analyzed on the server and various advertisements are transmitted along with the text as shown in the following figures. In FIG. 1, the client ChatterBox1 has sent a message saying “how about a movie?” Referring to FIG. 2, the message is appended to include an advertisement and is displayed inside the conversation panel. When the client moves their mouse cursor over the advertisement area the mouse cursor will be transformed into a hand cursor to indicate a clickable item which, when clicked, will launch the client's web browser and take them to the advertiser's desired web site.

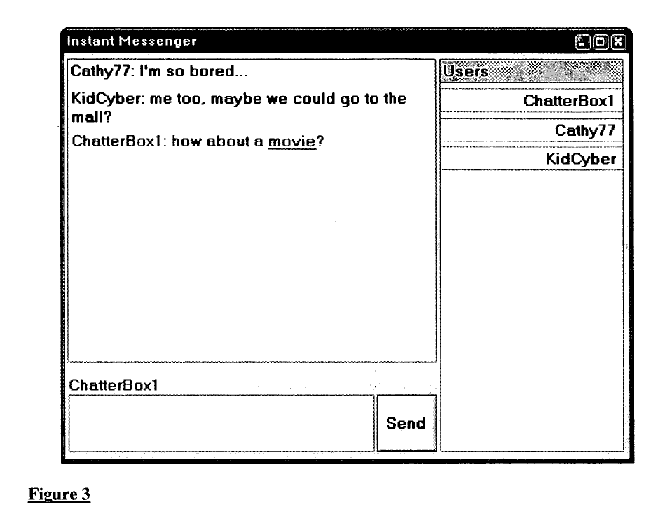

Referring to FIG. 3, the same message from the client ChatterBox1 saying “how about a movie?”, is dealt with in an alternative manner. The message is modified to highlight the word movie. When the client moves their mouse cursor over the highlighted word the mouse cursor will be transformed into a hand cursor to indicate a clickable item; which, when clicked, will launch the client's web browser and take them to the advertiser's desired web site.

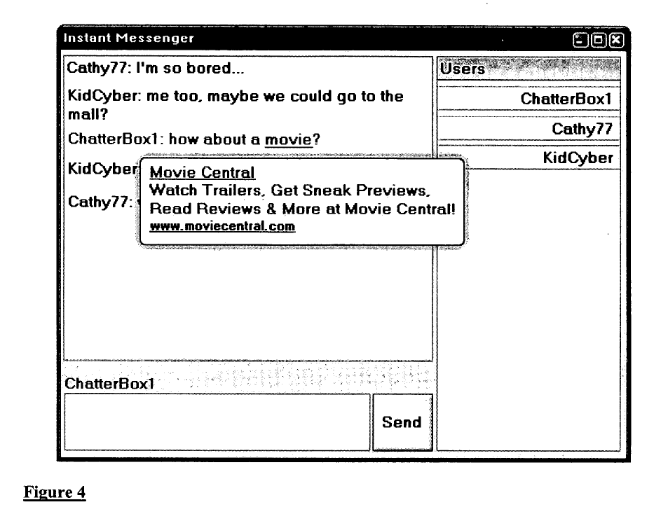

Referring to FIG. 4, the same message from the client ChatterBox1 saying “how about a movie?”, is dealt with in an alternative manner. The message is again modified to highlight the word movie. However, when the client moves their mouse cursor over the highlighted word the mouse cursor will be transformed into a hand cursor and will overlay a popup advertisement from the advertiser which, when clicked, will launch the client's web browser and take them to the advertiser's desired web site. The popup can be displayed in a variety of places inside the program and does not need to appear at a particular fixed location. The advertisements contained in the popup can be a mixture of audio/visual forms and are not limited to text.

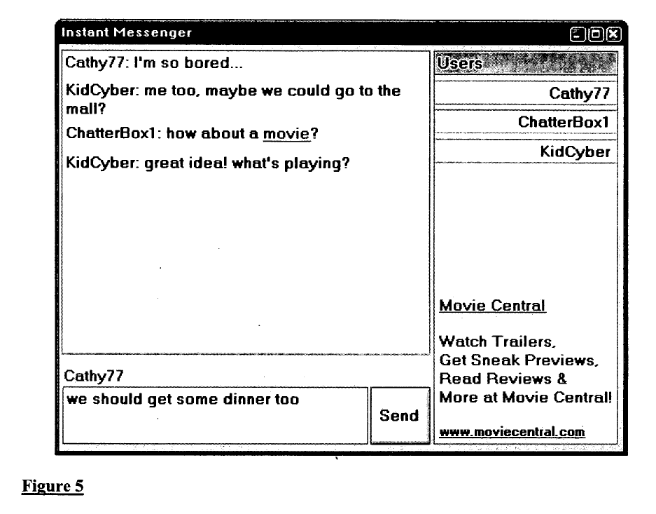

Referring to FIG. 5, the same message from the client ChatterBox1 saying “how about a movie?”, is dealt with in an alternative manner. The word movie typed by Chatterbox1 can still be highlighted (this can be configured to work as depicted in FIGS. 3 and 4) and an advertisement can be displayed in a sidebar panel. When the client moves their mouse cursor over the advertisement in the sidebar the mouse cursor will be transformed into a hand cursor which, when clicked, will launch the client's web browser and take them to the advertiser's desired web site. The advertisements can be a mixture of audio/visual forms and are not limited to text.

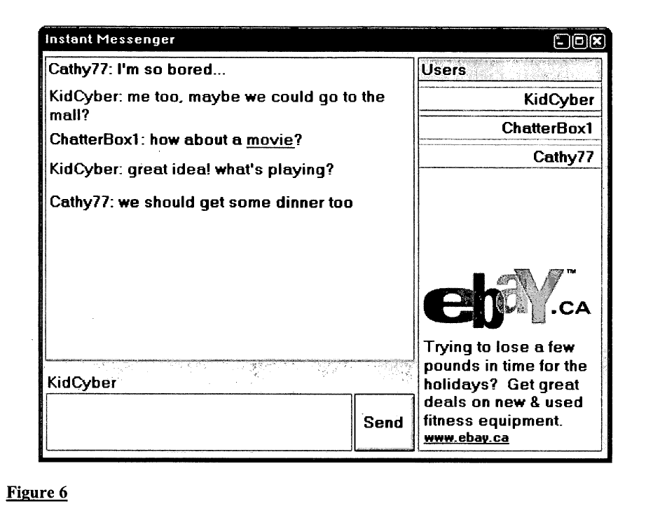

Referring to FIG. 5, the client Cathy77 sends a message saying “we should get some dinner too.” Referring to FIG. 6, the word “dinner” is linked to fitness equipment advertisements in the database. A sidebar panel advertisement appears regarding fitness equipment by ebay.ca (Trade Mark).

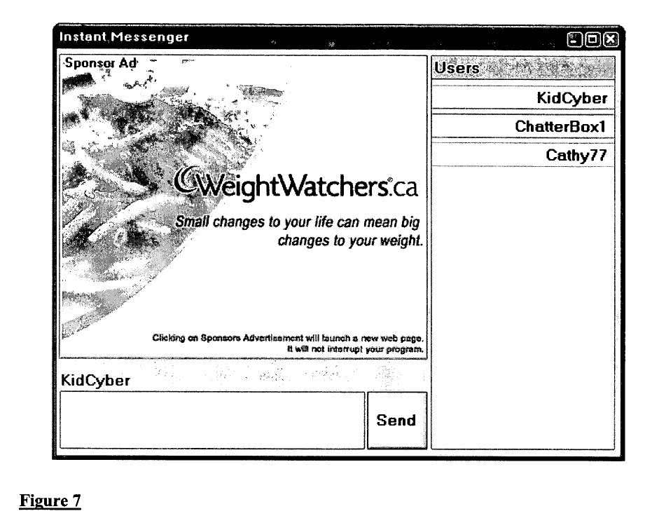

Referring to FIG. 7, assuming the client Cathy77 sends the same message saying “we should get some dinner too.”, the word “dinner” is linked to health and fitness advertisements. In this case, a large visual advertisement from weighpaneltwatchers.ca is displayed in the conversation panel. When the client moves their mouse cursor over the advertisement the mouse cursor will be transformed into a hand cursor which, when clicked, will launch the client's web browser and take them to the advertiser's desired web site. It should be noted that the advertisement could be configured so that it interrupts the clients chat for a certain period of time. The advertisement can be modified by the program or the server to give clients information about the advertisement. As depicted in the figure the advertisement could have the following additional tags:

Wording identifying the picture as a sponsor's ad, top left:

Sponsor Ad

Wording letting clients know what happens if they click on this ad, bottom right:

“Clicking on Sponsors Advertisement will launch a new web page.

It will not interrupt your program.”

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

What is claimed is:

1. A method of advertising to users of text messaging, comprising the steps of:
creating a database of keywords;
linking at least one advertisement to each keyword in the database of keywords;
analysing contents of an exchange of text messages sent between users of text messaging for the use of one keyword from the database of keywords; and
serving into the exchange of text messages the at least one advertisement which is linked to the one keyword from the database of keywords.
